(19) United States
(12) Patent Application Publication
(10) Pub. No.: US 2006/0053903 A1
(43) Pub. Date: Mar. 16, 2006

(54) Web tension indicator

(76) Inventors: Steven T. Berenyi, Indianapolis, IN (US); Guy R. Dingman, Westfield, IN (US); David D. Merrick, Cicero, IN (US); Michael Ayette, Noblesville, IN (US)

Correspondence Address: BARNES & THORNBURG, 11 SOUTH MERIDIAN, INDIANAPOLIS, IN, 46204, US

(21) Appl. No.: 11/222,382

(22) Filed: Sep. 8, 2005

Related U.S. Application Data
(60) Provisional application No. 60/610,133, filed on Sep. 15, 2004.

(51) Int. Cl. G01L 1/04

(52) U.S. Cl. 73/862.472

(57) ABSTRACT

A web tension indicator comprises a housing configured to receive a web therethrough, a spring member carried within the housing, and means for indicating that the web is under tension when a force resulting from tension applied to the web is applied by the web against the spring member. The spring member may be a linear or coiled spring.

### CROSS-REFERENCE TO RELATED U.S. APPLICATION

This patent application claims priority to and the benefit of U.S. Provisional patent application Ser. No. 60/610,133, filed Sep. 15, 2004, the disclosure of which is incorporated herein by reference.

### FIELD OF THE INVENTION

The present invention relates generally to restraint systems, and more specifically to restraint systems including one or more webs that may be placed under tension.

### BACKGROUND OF THE INVENTION

Active restraint systems for motor vehicles and child seats typically include one or more webs, belts, straps or tethers that may be attached to one or more anchor points associated with the vehicle and/or the vehicle or child seat to secure an occupant in the seat. Such webs, belts, straps or tethers are typically in a slack state, i.e., not under tension, prior to securing the occupant in the seat. The occupant or other individual then actively secures the one or more webs, belts, straps or tethers about the occupant. This process may also include adjusting the tension of one or more of the webs, belts, straps or tethers to remove slack and better secure the occupant in the seat. It is accordingly desirable to provide for a web tension indicating device that provides an indication of when a web, belt, strap or tether is under tension.

### SUMMARY OF THE INVENTION

The present invention may comprise one or more of the features recited in the attached claims and the following features and combinations thereof. A web tension indicator may comprise a housing configured to receive a web therethrough, a spring member carried within the housing, and means for indicating that the web is under tension when a force resulting from tension applied to the web is applied by the web against the spring member. The housing may define at least one channel therethrough.

The spring member may be a leaf spring having one side in contact with the web and an opposite side defining a tension indicating portion, and the means for indicating that the web is under tension may include the leaf spring responsive to the force applied by the web against the leaf spring to extend the tension indicating portion of the opposite side of the leaf spring adjacent to the at least one channel so that the tension indicating portion of the opposite side of the leaf spring is visible through the at least one channel. The leaf spring may be normally biased relative to the housing so that the tension indicating portion of the opposite side of the leaf spring is not visible through the at least one channel. The web may be visible through the at least one channel when the leaf spring is normally biased. The leaf spring may alternatively be configured so that a non-tension indicating portion thereof is visible through the at least one channel when the spring is normally biased relative to the housing.

The spring member may alternatively be a leaf spring having one side in contact with the web and the web may be positioned between the leaf spring and the at least one channel. The leaf spring may be normally biased relative to the housing to force the web into contact with the at least one channel. The means for indicating that the web is under tension may include the leaf spring responsive to the force applied by the web against the leaf spring to force the leaf spring and the web away from the at least one channel and into the housing. The housing may further define first and second web receiving ports at opposite ends thereof, with the first and second web receiving ports configured to receive the web therein. The means for indicating that the web is under tension may alternatively or additionally include the leaf spring responsive to the force applied by the web against the leaf spring to force at least a portion of the leaf spring outwardly away from one of the first and second web receiving ports of the housing.

The housing may be cylindrical, and the web tension indicator may include a barrel received longitudinally within the cylindrical housing with the spring member engaging the cylindrical housing and the barrel to resist rotation of the barrel within the housing, the housing and the barrel each configured to receive the web transversely therethrough. The cylindrical housing define at least one channel therein, and the means for indicating that the web is under tension may include the barrel responsive to the force applied by the web to overcome tension in the spring member and rotate the barrel relative to the housing to so that a tension indicating portion of the barrel is visible through the at least one channel. The spring member may be normally biased to position the tension indicating portion of the barrel away from the at least one channel of the housing so that the tension indicating portion of the barrel is not visible through the at least one channel.

These and other features of the present invention will become more apparent from the following description of the illustrative embodiments.

### BRIEF DESCRIPTION OF THE DRAWINGS

FIG. 1 is a bottom perspective exploded view of one illustrative embodiment of a web tension indicator.

FIG. 2 is a perspective view of the inner surface of the bottom housing member forming part of the web tension indicator of FIG. 1.

FIG. 3 is a perspective view of the tension indicating surface of the leaf spring forming part of the web tension indicator of FIG. 1.

FIG. 4 is a top perspective view of the assembled web tension indicator of FIG. 1.

FIG. 5 is a cross-sectional view of the web tension indicator of FIGS. 1 and 4 viewed along section lines 5-5.

FIG. 6 is a cross-sectional view similar to FIG. 5 including a portion of a web extending through the web tension indicator with the web under sufficiently low tension to allow the leaf spring to maintain its unbiased position relative to the housing.

FIG. 7 is a top-plan view of the web tension indicator of FIG. 6 illustrating that the web is visible through the tension indicator channels of the top housing member when the leaf spring is in its unbiased position.

FIG. 8 is a cross-sectional view similar to FIG. 6 with the web under sufficiently high tension to force the leaf spring into its fully extended position relative to the housing.

FIG. 9 is a top-plan view of the web tension indicator of FIG. 8 illustrating that the tension indicating surface of the leaf spring is visible through the tension indicator channels of the top housing member when the leaf spring is in its fully extended position.

FIG. 10 is a cross-sectional view similar to FIG. 5 illustrating an alternate embodiment of the spring member.

FIG. 11 is a top perspective exploded view of another illustrative embodiment of a web tension indicator.

FIG. 12 is a side elevational exploded view of the web tension indicator of FIG. 11 illustrating a portion of a web extending therethrough and illustrating motion of the leaf spring under different web tensions.

FIG. 13 is a side elevational view of the assembled web tension indicator of FIGS. 11 and 12 with the web under sufficiently low tension to allow the leaf spring to force the web upwardly through the tension indicator channel of the top housing member.

FIG. 14 is a side elevational view of the assembled web tension indicator of FIGS. 11 and 12 with the web under sufficient tension to force the leaf spring and web downwardly away from the tension indicator channel and into the housing.

FIG. 15 is a top plan view of the web tension indicator of FIG. 14 illustrating extension of a portion of the leaf spring outwardly away from the web port.

FIG. 16 is an exploded view of yet another illustrative embodiment of a web tension indicator.

FIG. 17 is a top-plan view of the web tension indicator of FIG. 16 with a portion of a web extending therethrough and illustrating that a low tension indicating surface of the rotatable barrel is visible through the tension indicator channel of the housing when the web is under sufficiently low tension.

FIG. 18 is a cross-sectional view of the web tension indicator of FIG. 17 viewed along section lines 18-18, illustrating the position of the rotatable barrel relative to the housing when the web is under sufficiently low tension to allow the coiled spring to maintain its unbiased position relative to the housing.

FIG. 19 is a top-plan view of the web tension indicator of FIG. 16 with a portion of a web extending therethrough and illustrating that a high tension indicating surface of the rotatable barrel is visible through the tension indicator channel of the housing when the web is under sufficiently high tension.

FIG. 20 is a cross-sectional view of the web tension indicator of FIG. 19 viewed along section lines 20-20, illustrating the position of the rotatable barrel relative to the housing when the web is under sufficiently high tension to rotate the barrel against the bias of the coiled spring.

### DESCRIPTION OF THE ILLUSTRATIVE EMBODIMENTS

For the purposes of promoting an understanding of the principles of the invention, reference will now be made to a number of illustrative embodiments illustrated in the drawings and specific language will be used to describe the same.

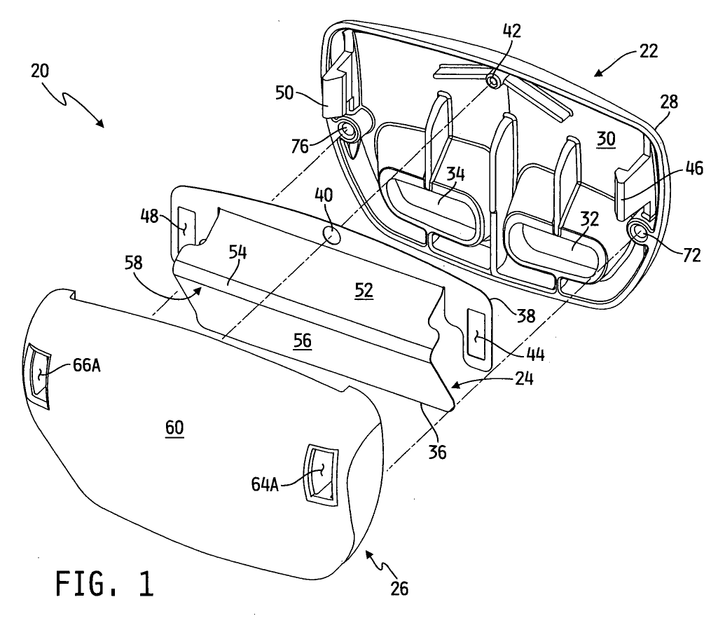

Referring to FIG. 1, a bottom perspective exploded view of one illustrative embodiment of a web tension indicator 20 is shown. In the illustrated embodiment, the web tension indicator 20 includes a top housing member 22, a spring member 24 and a bottom housing member 26, wherein the top housing member 22 and the bottom housing member 26 form a hollow housing with the spring member 24 located therein. The top housing member 22 has an outer surface 28 and an opposite inner surface 30, and in the illustrated embodiment the top housing member 22 defines a pair of channels 32 and 34 therein from the outer surface 28 through the inner surface 30. The top housing member 22 may alternatively define more or fewer such channels therein, although it will be understood that at least one such channel will be provided. Alternatively or additionally, the bottom housing member 26 may define one or more such channels therein.

The spring member 24 includes a mounting flange 38 and a leaf spring 36 extending from the mounting flange 38. The mounting flange 38 may be configured to be mounted to either or both of the top housing member 22 and the bottom housing member 26, and in the illustrated embodiment the mounting flange 38 is configured to be mounted to the top housing member 22 and secured thereto by the bottom housing member 26. For example, the mounting flange 38 defines a pair of openings 44 and 48 therethrough on either side of the mounting flange 38, wherein the openings 44 and 48 generally align with a corresponding pair of ears or tabs 46 and 50 respectively extending outwardly from the inner surface 30 of the top housing member 22. Between the openings 44 and 48 the mounting flange 38 defines a bore 40 that generally aligns with a correspondingly shaped protrusion 42 extending outwardly from the inner surface 30 of the top housing member 22. The mounting flange 38 is mounted to the top housing member 22 by passing the ears or tabs 46 and 50 through the respective openings 44 and 48 defined through the mounting flange 38 and also passing the protrusion 42 extending from the inner surface 30 of the top housing member 22 through the bore 48 defined through the mounting flange 38.

The leaf spring 36 extending from the mounting flange 38 of the spring member 24 has a first portion 52 that extends upwardly away from the mounting flange 38 to a peak 54, and a second portion 56 that extends downwardly away from the peak 54 to a free end of the leaf spring 36. The surface of the leaf spring 58 facing the bottom housing member 26 is designated for purposes of this document as the top surface 58 of the leaf spring 36. The underside surface 78 of the second portion 56 may be colored or otherwise marked for ready visual identification thereof as most clearly shown in FIG. 3. In the exemplary embodiment illustrated in FIG. 3, the underside surface 78 of the second portion 56 of the leaf spring 36 is represented as being red in color, although it will be understood that the underside surface 78 may alternatively be any color or provided with a suitable marking that, in any case, is readily identifiable when viewed through either of the channels 32 and 34 defined in the top housing member 22 as will be described in greater detail hereinafter.

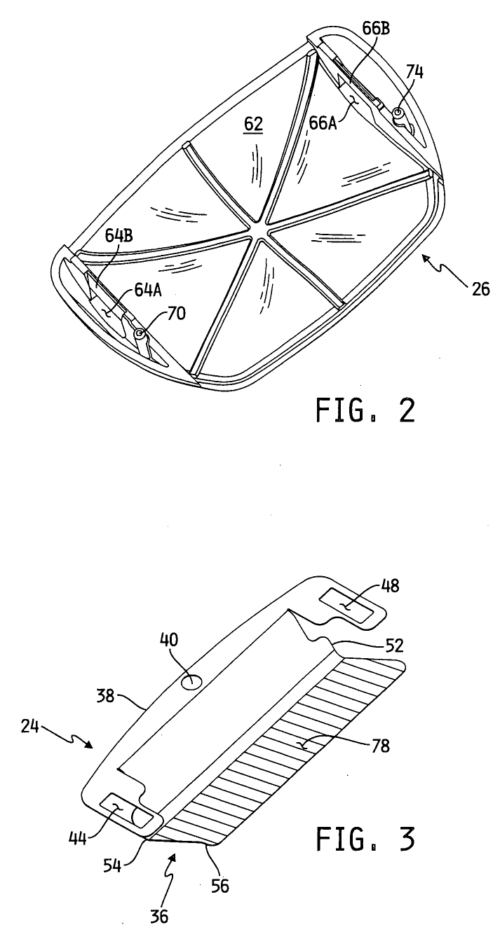

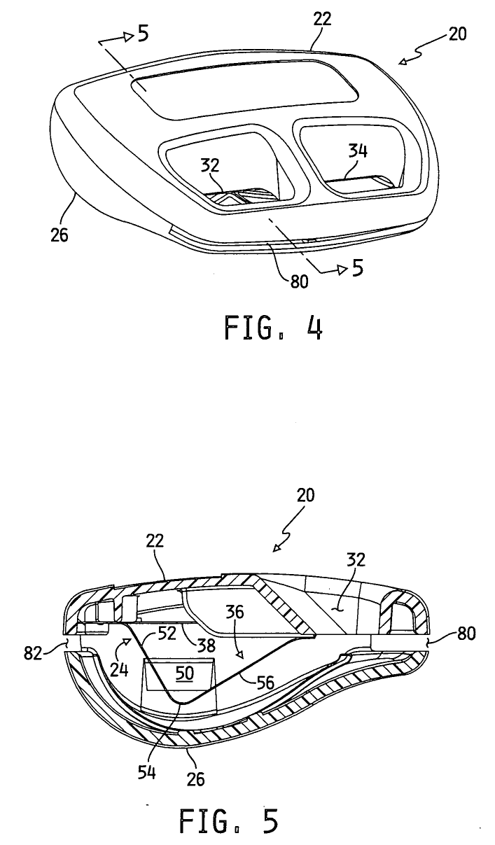

The bottom housing member 26 has an outer surface 60 and an inner surface 62, as most clearly shown in FIG. 2. The bottom housing member defines a pair or openings 64A and 66A adjacent to either side thereof that generally align with the ears or tabs 46 and 50 respectively of the top housing member 22. The inner surface 62 of the bottom housing member 26 defines complementarily configured ears or tabs 64B and 66B adjacent to the openings 64A and 66A respectively, wherein the ears or tabs 64B and 66B are configured to engage the corresponding ears or tabs 46 and 50 of the top housing member 22 when the ears or tabs 46 and 50 are passed through the respective openings 64A and 64B of the bottom housing member 26. Additionally, the inner surface 62 of the bottom housing member 26 defines a pair of protrusions 70 and 74 adjacent to the ears or tabs 64B and 66B respectively that align with corresponding bores 72 and 76 defined in the inner surface 30 of the top housing member 22. During assembly, the mounting flange 38 of the spring member 24 is first mounted to the inner surface 30 of the top housing member 22 as described above. The top and bottom housing members 22 and 26 are then brought together with the protrusions 70 and 74 received within the respective bores 72 and 76 when the ears or tabs 46 and 50 are received within the openings 64A and 66A respectively, and the ears or tabs 46 and 50 engage the correspondingly configured ears or tabs 64B and 66B to lock the bottom housing member 26 to the top housing member 22 with the mounting flange 38 of the spring member 24 secured between the top and bottom housing members 22 and 26. The resulting web tension indicator 20 is illustrated in the top perspective view of FIG. 4. It will be appreciated that the top and bottom housing members 22 and 26 respectively may be joined using other known housing joining techniques and/or structures, and any such alternate housing joining arrangement is intended to fall within the scope of the claims appended hereto.

Referring now to FIG. 5, a cross-section of the web tension indicator 20 is shown, as viewed through the section lines 5-5 of FIG. 4. In this view, it can be seen that the top and bottom housing members 22 and 26 define first and second web ports 80 and 82 respectively therebetween, wherein the first web port 80 is defined at one end of the web tension indicator 20 and the second web port 82 is defined at the opposite end of the web tension indicator 20. The leaf spring 36 is normally biased so that the peak 54 extends downwardly toward the bottom housing member 26 and the second portion 56 is retracted from both of the channels 32 and 34 so that the underside surface 78 of the second portion 56 generally cannot be seen through the channels 32 and 34.

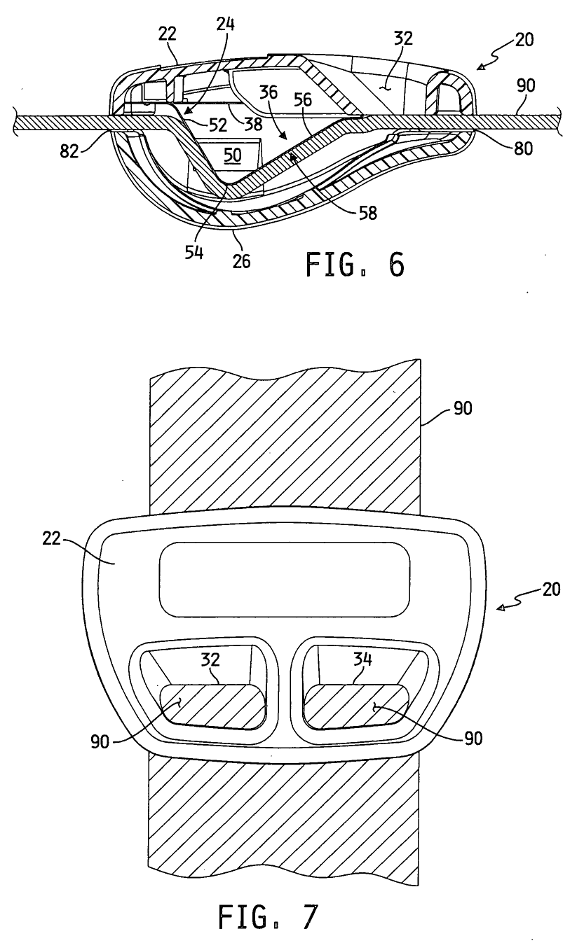

Referring now to FIG. 6, a cross-sectional view similar to that of FIG. 5 is shown except that a web 90 extends through the housing, via the web ports 80 and 82, and in contact with the top surface 58 of the leaf spring 36. In the illustrated embodiment, the web 90 represents a conventional vehicle seat belt, although it will be understood that the web 90 may generally represent a fabric and/or synthetic harness or anchoring web, belt, tether or other restraint strap or harness. In any case, when the web 90 has little or no tension, it may be moved through the web tension indicator 20 in either direction generally without deflecting the leaf spring 36 and causing the second portion 56 to move sufficiently toward the channels 32 and 34 so that the underside surface 78 of the second portion 56 becomes visible through the channels 32 and 34. Under these conditions, the surface of the web 90 is visible through the channels 32 and 34 as shown in FIG. 7. It will be noted that in FIG. 7 the web 90 is represented as being brown in color, although it will be understood that the web 90 may alternatively be any color or provided with a suitable marking or design. In any case, it is desirable for the color, brightness, marking and/or design of the underside surface 78 of the second portion 56 of the leaf spring 36 to be sufficiently different from that of the web 90 so that the two may be readily differentiated when viewed through the channels 32 and 34.

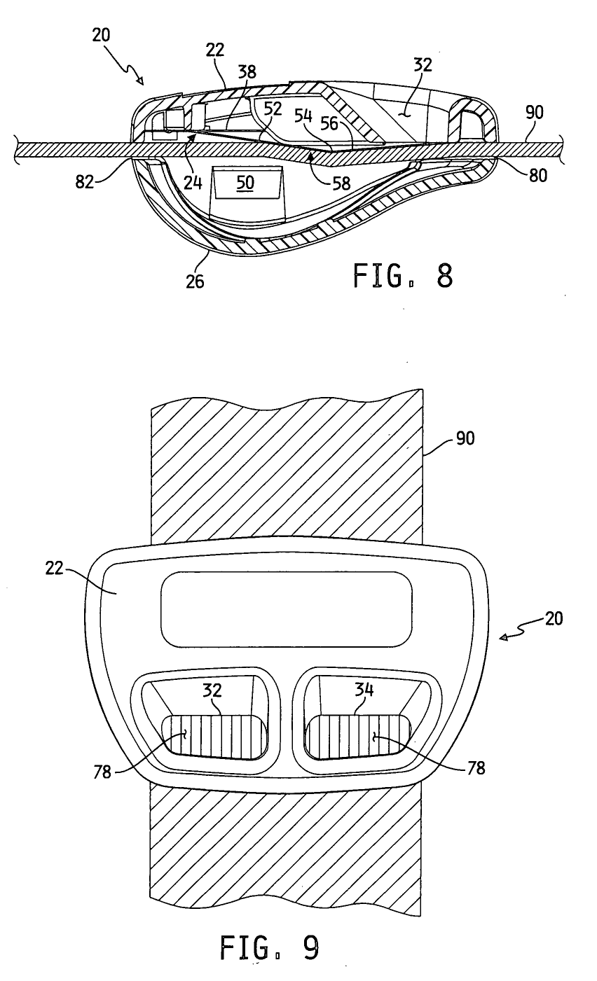

Referring now to FIG. 8, a cross-sectional view similar to that of FIG. 6 is shown except that in this view the leaf spring 36 has responded to a sufficiently high force applied by the web 90 against the peak 54 and portions 52 and 56 of the leaf spring 36 to move the leaf spring 36 toward the top housing member 22 so that the tension indicating portion or surface 78 of the leaf spring 36 extends toward the channels 32 and 34 until the tension indicating portion 78 of the spring member 24 is visible through the channels 32 and 34. The force applied by the web 90 against the leaf spring 36 results from tension applied to the web 90, such as when the web 90 is being secured to one or more anchor points and/or when the web 90 is being tightened against a vehicle occupant or other object after being secured to one or more anchor points. The sufficiently high force required by the web 90 to cause the leaf spring 36 to fully extend toward the top housing member 22 as illustrated in FIG. 8 is determined by the amount of bias or resistance in the leaf spring 36. It will be appreciated that the spring member 24, and the leaf spring 36 in particular, will accordingly be designed to achieve a desired bias or resistance that corresponds to the amount of force required to be applied by the web 90 against the leaf spring 36 as a result of tension on the web 90 to move the leaf spring 36 to its fully extended position shown in FIG. 8. The desired bias or resistance of the spring member 24 generally, and of the leaf spring 36 in particular, will generally be a function of the specific application of the web tension indicator 20. In any case, as the tension of the web 90 increases, the underside surface 78 of the second leaf portion 56 extends toward, and eventually over, the channels 32 and 34 and therefore becomes visible through the channels 32 and 34. When the force applied by the web 90 on the leaf spring 36 is sufficiently high, the leaf spring 36 will be fully extended as illustrated in FIG. 8 and the underside surface 78 of the leaf spring 36 is visible through the channels 32 and 34, as illustrated in FIG. 9, to thereby indicate that the web 90 is under tension and is taut. It will be noted that in FIG. 9 the web 90 is represented as being brown in color and the underside surface 78 of the leaf spring 36 is represented as being red in color, although it will be understood that the web 90 and the underside surface 78 of the leaf spring 36 may alternatively be any color and/or brightness, and/or provided with a suitable marking or design. In any case, it is desirable for the color, brightness, marking and/or design of the underside surface 78 of the second portion 56 of the leaf spring 36 to be sufficiently different from that of the web 90 so that the two may be readily differentiated when viewed through the channels 32 and 34.

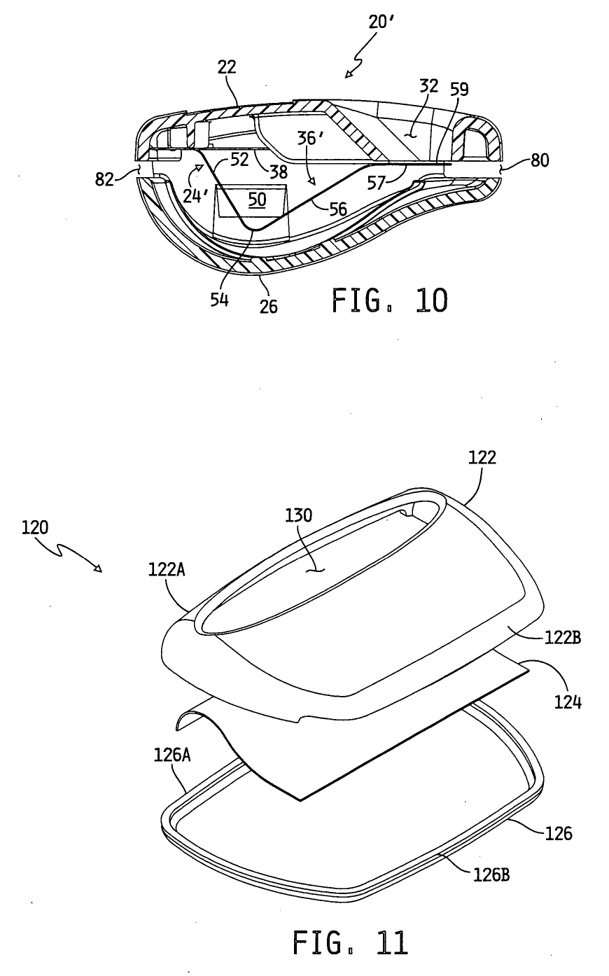

Referring now to FIG. 10, an alternate embodiment 20′ of the web tension indicator of FIGS. 1-9 is shown. The web tension indicator 20′ is identical in many respects to the web tension indicator 20 illustrated and described with respect to FIGS. 1-9, and like numbers are therefore used to identify like components. In the alternate embodiment illustrated in FIG. 10, the top and bottom housing members 22 and 26 are unchanged, but the spring member 24′ is configured differently than the spring member 24. Specifically, the leaf spring 36′ includes a third portion 57 that extends from the second portion 56. The third portion 57 of the leaf spring 36′ is oriented relative to the second portion 56 so that an underside surface 59 of the third portion 57 extends over the channels 32 and 34 when the leaf spring 36′ is in its normally biased position as illustrated in FIG. 10. In one embodiment, the underside surface 59 of the third portion 57 of the leaf spring 36′ is colored in contrast to the color of the underside surface 78 of the second portion 56, although it will be understood that the underside surface 59 may alternatively be any color or provided with a suitable marking or design. In any case, it is desirable for the color, brightness, marking and/or design of the underside surface 59 of the third portion 59 of the leaf spring 36′ to be sufficiently different from the color, brightness, marking and/or design of the second portion 56 of the leaf spring 36′ so that the two may be readily differentiated when viewed through the channels 32 and 34.

When the web 90 has little or no tension, such as illustrated in FIG. 6, it may be moved through the web tension indicator 20′ in either direction generally without deflecting the leaf spring 36′ and causing the second portion 56 to move sufficiently toward the channels 32 and 34 so that the underside surface 78 of the second portion 56 becomes visible through the channels 32 and 34. Under these conditions, the underside surface 59 of the leaf spring 36′ is visible through the channels 32 and 34 as shown in FIG. 10. When a sufficiently high force resulting from tension applied to the web 90 is applied by the web 90 to the peak 54 and portions 52 and 56 of the leaf spring 36′, the leaf spring 36′ moves toward the top housing member 22 so that the tension indicating portion or surface 78 of the leaf spring 36′ extends toward the channels 32 and 34 until the tension indicating portion 78 of the spring member 24 is visible through the channels 32 and 34 as was shown in FIG. 8. When the force applied by the web 90 on the leaf spring 36′ is sufficiently high, the leaf spring 36′ will be fully extended, as was illustrated in FIG. 8, and the underside surface 78 of the leaf spring 36′ will be visible through the channels 32 and 34, as was illustrated in FIG. 9, to thereby indicate that the web 90 is under tension and is taut.

It will be appreciated that the spring member 24 or 24′, the top housing member 22 and/or the bottom housing member 26 may be alternatively configured such that some portion of the spring member 24 or 24′ other than that indicated above is visible through one or more channels defined in the top housing member 22 and/or bottom housing member 26 when the web 90 is not under tension, and/or that some other portion of the spring member 24 or 24′ other than that indicated above is visible through the one or more channels defined in the top housing 22 and/or bottom housing 26 when the web is under tension. In such embodiments, the two portions of the spring member 24 or 24′ that may be visible through the one or more channels should be sufficiently different in color, brightness, marking and/or design such that they are readily distinguishable and that so it will become readily apparent when viewing the one or more channels whether the web 90 is, or is not, under tension.

Referring now to FIG. 11, a front perspective and exploded view of another illustrative embodiment of a web tension indicator 120 is shown. In the illustrated embodiment, the web tension indicator 120 includes a top housing member 122, a spring member 124 and a bottom housing member 126, wherein the top housing member 122 and the bottom housing member 126 form a hollow housing with the spring member 124 located therein. The top housing member 122 defines a single channel 130 therein from its outer surface through its inner surface. The top housing member 122 may alternatively define more or fewer such channels therein, although it will be understood that at least one such channel will be provided. Alternatively or additionally, the bottom housing member 126 may define one or more such channels therein.

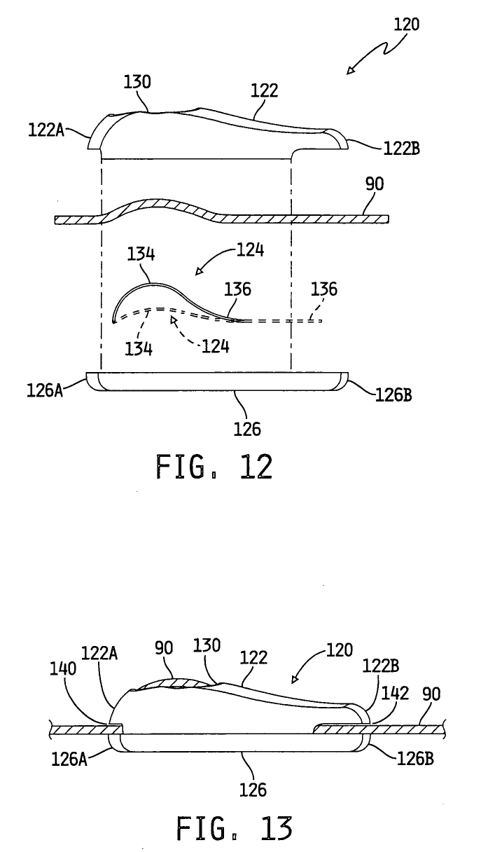

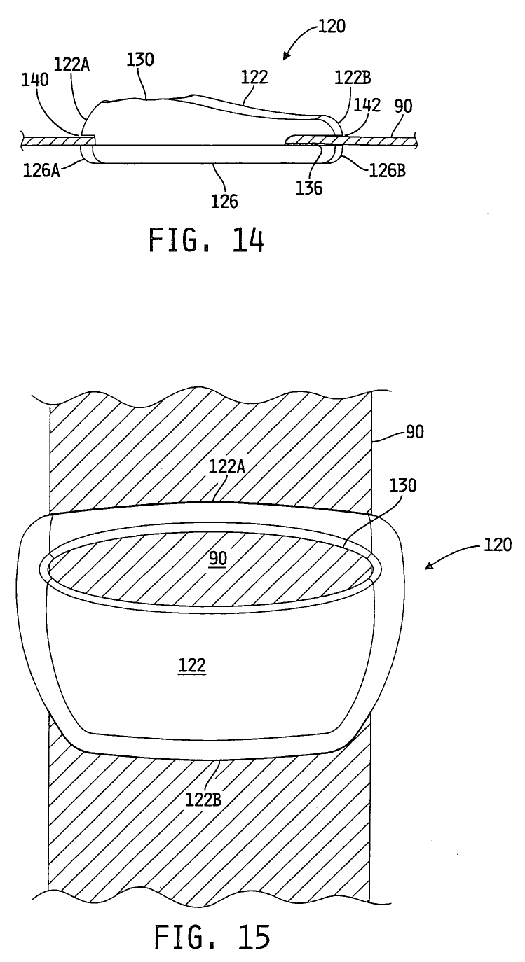

Referring to FIG. 12, a side elevational and exploded view of the web tension indicator 120 is shown with a length of web 90 extending through the web tension indicator 120 between the spring member 124 and the top housing member 122. As most clearly illustrated in FIG. 13, one end 122A of the top housing member 122 and one corresponding end 126A of the bottom housing member 126 cooperate to define a first web receiving port 140, and an opposite end 122B of the top housing member 122 and corresponding end 126B of the bottom housing member 126 cooperate to define a second web receiving port 142. The web 90 is received through the web tension indicator 120 via the first and second web receiving ports 140 and 142 as illustrated in FIG. 13.

Referring again to FIG. 12, the spring member 124 is illustrated in this exemplary embodiment as being a leaf spring having a peak portion 134 extending upwardly from the bottom housing member 126 toward and aligned with the channel 130 of the top housing member 122, and a sloped portion 136 extending away from the peak portion 134 toward the bottom housing member 126. It will be understood that in embodiments of the web tension indicator 120 that include multiple channels defined through the top housing member 122, the spring member 126 may likewise define a corresponding number of peak portions 134 that align with corresponding ones of the number of channels. In any case, as shown in phantom in FIG. 12, when a sufficiently high force resulting from tension on the web 90 is applied by the web 90 on the spring member 124, the peak portion 134 moves downwardly toward the bottom housing member 126, and the sloped portion 136 extends toward the second web receiving port 142 defined by the ends 122B and 126B of the top and bottom housing members 122 and 126 respectively.

Referring again to FIG. 13, the leaf spring 124 is normally biased (as shown in FIG. 12) relative to the top and bottom housing members 122 and 126, so that when the web 90 has little or no tension the peak portion 134 of the leaf spring 124 forces the web 90 against the inner surface of the top housing member and into contact with the open channel 130. Under these conditions, the surface of the web 90 is clearly visible through the channel 130 as shown in FIG. 13. Referring now to FIG. 14, a side elevational view similar to that of FIG. 13 is shown except that in this view the leaf spring 130 has responded to a sufficiently high force applied by the web 90, as a result of tension on the web 90, against the leaf spring 130 to move the peak portion 134 of the leaf spring 130 toward the bottom housing member 122 (see FIG. 12) so that the leaf spring 124 and the web 90 contacting the leaf spring 124 become recessed within the channel 130. When the force applied by the web 90 on the leaf spring 124 is sufficiently high, at least some of the sloped portion 136 of the leaf spring 130 extends outwardly from the second web port 142 adjacent to the web 90 as illustrated in FIGS. 14 and 15. The force applied by the web 90 against the leaf spring 130 results from tension applied to the web 90, such as when the web 90 is being secured to one or more anchor points and/or when the web 90 is being tightened against a vehicle occupant or other object after being secured to one or more anchor points. The sufficiently high force required by the web 90 to cause the leaf spring 124 to fully extend as illustrated in FIGS. 12, 14 and 15, is determined by the amount of bias or resistance in the leaf spring 124. It will be appreciated that the leaf spring 124 will accordingly be designed to achieve a desired bias or resistance that corresponds to the amount of force required to be applied by the web 90 against the leaf spring 124, as a result of tension on the web 90, to move the leaf spring 124 to its fully extended position shown in FIGS. 12, 14 and 15. The desired bias or resistance of the leaf spring 124 will generally be a function of the specific application of the web tension indicator 120. In any case, as the tension of the web 90 increases, the peak portion 134 of the leaf spring 124 and the portion of the web 90 in contact therewith moves inwardly away from the channel 130 and into the housing defined by the top and bottom housing members 122 and 126, and the sloped portion 136 of the leaf spring 124 extends toward the web receiving port 142. When the force applied by the web 90 on the leaf spring 124 is sufficiently high, the leaf spring 124 will be fully extended, as illustrated in FIG. 12, and at least a portion of the sloped portion 136 of the leaf spring 124 will extend outwardly from the web receiving port 142, as illustrated in FIGS. 14 and 15, to thereby indicate that the web 90 is under tension and is taut. It will be noted that in FIG. 15 the web 90 is represented as being brown in color and the sloped portion 136 of the leaf spring 124 is represented as being red in color, although it will be understood that the web 90 and the sloped portion 136 of the leaf spring 124 may alternatively be any color and/or brightness, and/or provided with a suitable marking or design. In any case, it is desirable for the color, brightness, marking and/or design of the sloped portion 136 of the leaf spring 124 to be sufficiently different from that of the web 90 so that the two may be readily differentiated.

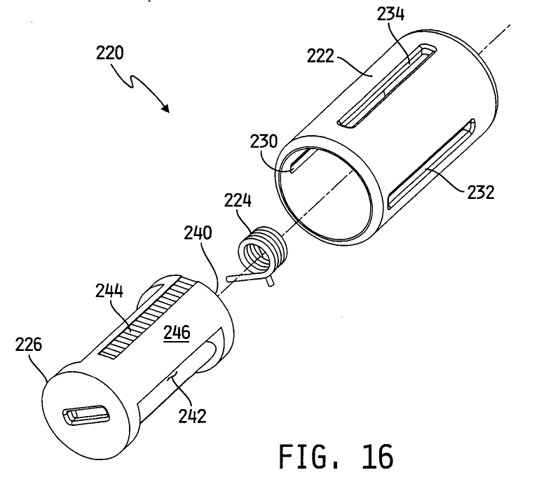

Referring to FIG. 16, an exploded view of yet another illustrative embodiment of a web tension indicator 220 is shown. In the illustrated embodiment, the web tension indicator 220 includes an open cylindrical housing 222, a spring member 224 and a barrel 226, wherein the barrel 226 is configured to be received longitudinally within the cylindrical housing 222. The housing 222 defines a channels 234 therein from its outer surface through its inner surface. The housing 222 may alternatively define more or fewer such channels therein, although it will be understood that at least one such channel will be provided.

The spring member 224 is mounted to a spring mounting protrusion 240 extending longitudinally from one end of the barrel 226, and is configured to engage the housing 222 when the barrel 226 is longitudinally received within the housing 222. The spring member 224 engages the housing 222 and the barrel 226, and the bias in the spring member 224 resists rotation of the barrel 226 within the housing 222. In the illustrated embodiment, the spring member 224 is a coil spring. The housing 222 further defines first and second transverse web receiving ports 230 and 232, and the barrel 226 defines a channel 242 transversely therethrough. The barrel 226 and cylindrical housing 222 are accordingly configured to receive a web transversely therethrough when the barrel 226 is positioned within the housing 222. Such a web may extend through the channel 242 of the barrel 226, and also through the web receiving ports 230 and 232 of the housing 222.

The barrel 226 has an outer surface 246 that defines a tension indicating surface 244 longitudinally along a portion thereof. The barrel 226 is oriented within the housing 222 so that only the surface 246 of the barrel 226 is visible through the channel 234 in the housing 222 when the spring is normally biased, such as when the web is under little or no tension. When tension is applied to the web, the web applies a force to the barrel 226 that causes the barrel 226 to overcome the bias or tension in the spring member 224 and rotate relative to the housing 222 so that the tension indicating surface 244 becomes visible through the channel 234. The tension indicating surface 244 of the barrel 226 may be colored or otherwise marked for ready visual identification thereof. In the exemplary embodiment illustrated in FIG. 16, the tension indicating surface 244 of the barrel 226 is represented as being red in color, although it will be understood that the tension indicating surface 244 may alternatively be any color or provided with a suitable marking that, in any case, is readily identifiable when viewed through the channel 134 defined in the housing member 222 as will be described in greater detail hereinafter.

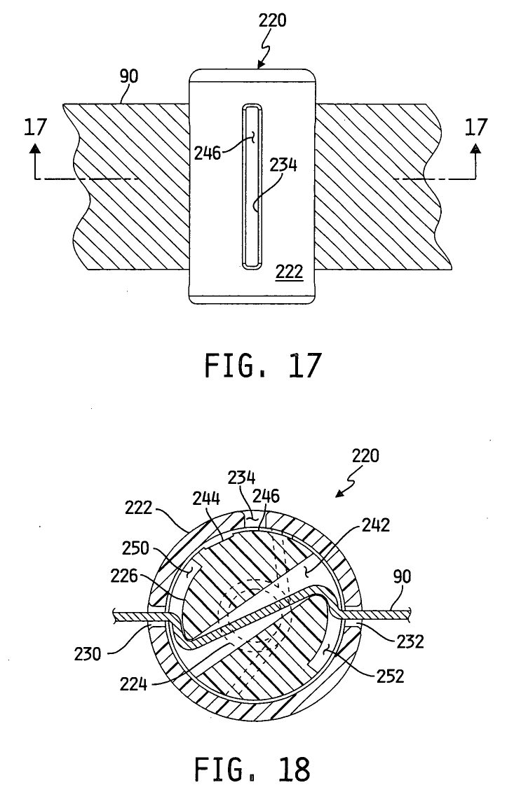

Referring now to FIGS. 17 and 18, a web 90 is shown extending through the channel 242 defined through the barrel 226 and also through the housing 222, via the web receiving ports 230 and 232. In the illustrated embodiment, the web 90 represents a conventional vehicle seat belt, although it will be understood that the web 90 may generally represent a fabric and/or synthetic harness or anchoring web, belt, tether or other restraint strap or harness. In any case, when the web 90 has little or no tension, the spring member 224 is biased to rotate the tension indicating surface 244 of the barrel 226 away from the channel 234 as most clearly shown in FIG. 17. In the illustrated embodiment, the spring member 224 is configured to normally bias the tension indicating surface 244 of the barrel 226 in a counterclockwise direction away from the channel 234, although it may alternatively be configured to normally bias the tension indicating surface 244 of the barrel 226 in a clockwise direction away from the channel 234. In either case, the outer surface 246 of the barrel 226 that does not define the tension indicating surface 244 is visible through the channel 234 when the web 90 has little or no tension. It will be noted that in FIG. 17 the outer surface 246 of the barrel 226 that does not define the tension indicating surface 244 is represented as being white in color, although it will be understood that the outer surface 246 may alternatively be any color or provided with a suitable marking or design. In any case, it is desirable for the color, brightness, marking and/or design of the tension indicating surface 244 of the barrel 226 to be sufficiently different from that of the remaining outer surface 246 of the barrel 226 so that the two may be readily differentiated when viewed through the channel 234.

It will be noted that when the spring member 224 is normally biased, such as when the web 90 has little or no tension, the channel 242 defined transversely through the barrel 226 is misaligned relative to the web receiving ports 230 and 232 of the housing 222 as illustrated in FIG. 18. To keep the web 90 from binding between the barrel 226 and the housing 222, recesses or channels 250 and 252 are defined along at least a portion of the outer surface 246 of the barrel 226 adjacent to either side of the channel 242. The channels 250 and 252 provide recesses adjacent to the web receiving ports 230 and 232 and are sized to accommodate the web 90 therein when the channel 242 is misaligned relative to the ports 230 and 232 to inhibit binding, pinching and/or trapping of the web between the barrel 226 and the housing 222 when the barrel 226 is rotated relative to the housing 222.

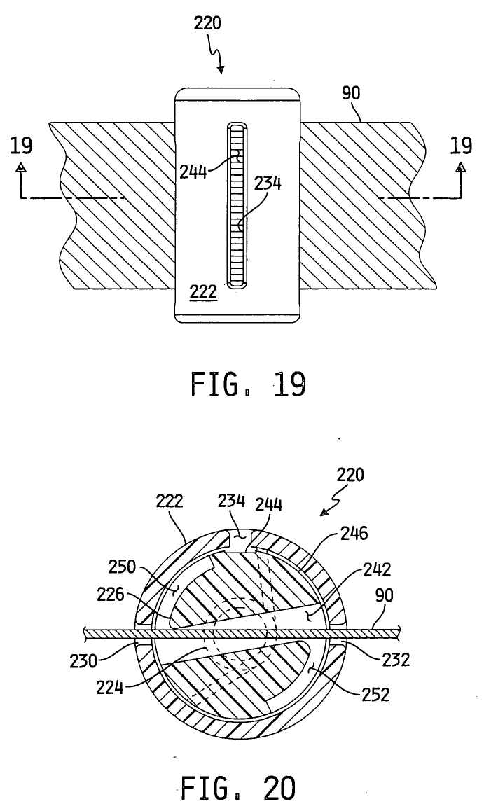

Referring now to FIGS. 19 and 20, the web tension indicator 220 is shown with the web 90 under tension. In these views, the spring member 224 has responded to a sufficiently high force applied by the web 90 against the channel 242 of the barrel 226 to rotate the barrel 226 relative to the housing 222 so that the tension indicating surface 244 of the barrel 226 moves toward the channel 234 until the tension indicating surface 244 is visible through the channel 234. The force applied by the web 90 against the barrel 226 results from tension applied to the web 90, such as when the web 90 is being secured to one or more anchor points and/or when the web 90 is being tightened against a vehicle occupant or other object after being secured to one or more anchor points. The sufficiently high force required by the web 90 to cause the barrel 226 to rotate within the housing 222 so that the tension indicating surface 244 is visible through the channel 230 as illustrated in FIGS. 19 and 20 is determined by the amount of bias or resistance in the spring member 224. It will be appreciated that the spring member 224 will accordingly be designed to achieve a desired bias or resistance that corresponds to the amount of force required to be applied by the web 90, as a result of tension on the web 90, against the barrel 226 to rotate the barrel 226 to the position shown in FIGS. 19 and 20. The desired bias or resistance of the spring member 224 will generally be a function of the specific application of the web tension indicator 220. In any case, as the tension of the web 90 increases, the tension indicating surface 244 of the barrel 226 rotates toward, and eventually over, the channel 234 and therefore becomes visible through the channels 234. When the force applied by the web 90 on the barrel 226 is sufficiently high, the barrel 226 will be fully rotated relative to the housing 222 and the tension indicating surface 244 of the barrel 226 is visible through the channel 234 to thereby indicate that the web 90 is under tension and is sufficiently taut. It will be noted that in FIG. 19 the tension indicating surface 234 of the barrel 226 is represented as being red in color and the outer surface of the housing 222 as being white in color, although it will be understood that the housing 222 and the tension indicating surface 234 of the barrel 226 may alternatively be any color and/or brightness, and/or provided with a suitable marking or design. In any case, it is desirable for the color, brightness, marking and/or design of the tension indicating surface 244 of the barrel 226 to be sufficiently different from that of the both the outer surface 246 of the barrel 226 that does not define the tension indicating surface and the outer surface of the housing 222 so that the tension indicating surface 244 of the barrel 226 may be readily differentiated from both the outer surface 246 of the barrel 226 that does not define the tension indicating surface 244 and the outer surface of the housing 222 when viewed through the channels 234.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, the various web tension indicator embodiments described herein each provide for a visual indicator of when the web is under tension. Alternatively or additionally, such an indicator may be provided in the form of an audible or tactile indicator. The means for indicating that the web is under tension when a sufficiently high force is applied by the web against the spring member is thus intended to include and encompass any one or a combination of a visual, audible, tactile or other indication.

What is claimed is:

1. A web tension indicator comprising:
a housing configured to receive a web therethrough,
a spring member carried within the housing, and
means for indicating that the web is under tension when a force, resulting from tension applied to the web, is applied by the web against the spring member.

2. The web tension indicator of claim 1 wherein the housing defines at least one channel therethrough, and wherein the spring member is a leaf spring having one side in contact with the web and an opposite side defining a tension indicating portion,
and wherein the means for indicating that the web is under tension includes the leaf spring responsive to the force applied by the web against the leaf spring to extend the tension indicating portion of the opposite side of the leaf spring adjacent to the at least one channel so that the tension indicating portion of the opposite side of the leaf spring is visible through the at least one channel.

3. The web tension indicator of claim 2 wherein the leaf spring is normally biased relative to the housing so that the tension indicating portion of the opposite side of the leaf spring is not visible through the at least one channel.

4. The web tension indicator of claim 3 wherein the web is visible through the at least one channel when the leaf spring is normally biased.

5. The web tension indicator of claim 2 wherein the opposite side of the leaf spring further defines a non-tension indicating portion,
and wherein the leaf spring is normally biased relative to the housing so that the non-tension indicating portion of the opposite side of the leaf spring is visible through the at least one channel.

6. The web tension indicator of claim 1 wherein the housing defines at least one channel therethrough, and wherein the spring member is a leaf spring having one side in contact with the web, and wherein the web is positioned between the leaf spring and the at least one channel, the leaf spring being normally biased relative to the housing to force the web into contact with the at least one channel,
and wherein the means for indicating that the web is under tension includes the leaf spring responsive to the force applied by the web against the leaf spring to force the leaf spring and the web away from the at least one channel and into the housing.

7. The web tension indicator of claim 6 wherein the housing defines first and second web receiving ports at opposite ends thereof, the first and second web receiving ports configured to receive the web therein, and wherein the means for indicating that the web is under tension further includes the leaf spring responsive to the force applied by the web against the leaf spring to force at least a portion of the leaf spring outwardly away from one of the first and second web receiving ports of the housing.

8. The web tension indicator of claim 1 wherein the housing defines first and second web receiving ports at opposite ends thereof, the first and second web receiving ports configured to receive the web therein, wherein the housing defines at least one channel therethrough, and wherein the spring member is a leaf spring in contact with the web, the leaf spring being normally biased relative to the housing to locate the leaf spring within the housing,
and wherein the means for indicating that the web is under tension includes the leaf spring responsive to the force applied by the web against the leaf spring to force at least a portion of the leaf spring outwardly away from one of the first and second web receiving ports of the housing.

9. The web tension indicator of claim 1 wherein the housing is cylindrical.

10. The web tension indicator of claim 9 further including a barrel received longitudinally within the cylindrical housing with the spring member engaging the cylindrical housing and the barrel to resist rotation of the barrel within the housing, the housing and the barrel each configured to receive the web transversely therethrough.

11. The web tension indicator of claim 10 wherein the cylindrical housing defines at least one channel therein,
and wherein the means for indicating that the web is under tension includes the barrel responsive to the force applied by the web to overcome tension in the spring member and rotate the barrel relative to the housing to so that a tension indicating portion of the barrel is visible through the at least one channel.

12. The web tension indicator of claim 11 wherein the spring member is normally biased to position the tension indicating portion of the barrel away from the at least one channel of the housing so that the tension indicating portion of the barrel is not visible through the at least one channel.

13. A web tension indicator comprising:
a housing configured to receive a web therethrough, the housing defining therein at least one channel, and
a spring member carried within the housing and defining a tension indicating portion, the spring member responsive to a force applied by the web against the spring member, resulting from tension applied to the web, to move the tension indicating portion of the spring member so that the tension indicating portion of the spring member is visible through the at least one channel.

14. The web tension indicator of claim 13 wherein the spring member is normally biased so that the tension indicating portion of the spring member is not visible through the at least one channel.

15. The web tension indicator of claim 14 wherein the web is visible through the at least one channel when the spring member is normally biased.

16. The web tension indicator of claim 14 wherein the spring member further includes a non-tension indicating portion,
and wherein the non-tension indicating portion of the spring member is visible through the at least one channel when the spring member is normally biased.

17. The web tension indicator of claim 13 wherein the housing includes a top housing member and a bottom housing member defining a housing inner therebetween, and wherein the spring member is attached to one of the top housing member and the bottom housing member.

18. The web tension indicator of claim 17 wherein the spring member includes a spring attachment flange attached to the one of the top housing member and the bottom housing member and a leaf spring extending from the spring attachment flange, the leaf spring having one surface in contact with the web and an opposite surface defining the tension indicating portion.

19. The web tension indicator of claim 18 wherein the spring member is normally biased so that the leaf spring extends away from the spring attachment flange to a peak in the direction of the bottom housing member and then away from the peak toward the top housing member.

20. The web tension indicator of claim 19 wherein the tension indicating portion of the spring member is not visible through the at least one channel when the spring member is normally biased.

21. The web tension indicator of claim 20 wherein the web is visible through the at least one channel when the spring member is normally biased.

22. The web tension indicator of claim 20 wherein the spring member includes a non-tension indicating portion,
and wherein the non-tension indicating portion of the spring member is visible through the at least one channel when the spring member is normally biased.

23. The web tension indicator of claim 20 wherein the force applied by the web against the spring member is applied against the peak of the leaf spring to move the peak of the leaf spring toward the top housing member so that the tension indicating portion of the spring member extends toward the at least one channel until the tension indicating portion of the spring member is visible through the at least one channel.

24. A web tension indicator comprising:
a housing configured to receive a web therethrough, the housing defining therein at least one channel, and
a spring member carried within the housing with the web positioned between the spring member and the at least one channel, the spring member being normally biased relative to the housing to force the web into contact with the at least one channel, the spring member being responsive to a force applied by the web against the spring member, resulting from tension applied to the web, to force the spring member and the web away from the at least one channel and into the housing.

25. The web tension indicator of claim 24 wherein the housing defines first and second web ports at opposite ends thereof, the first and second web ports configured to receive the web therein, and wherein the spring member is responsive to the force applied by the web against the spring member to force at least a portion of the spring member outwardly away from one of the first and second web ports of the housing.

26. The web tension indicator of claim 24 wherein the housing includes a top housing member and a bottom housing member defining a housing interior therebetween, and wherein the spring member is positioned within the housing interior.

27. The web tension indicator of claim 24 wherein the spring member is a leaf spring having at least one peak portion aligned with the at least one channel and a sloped portion extending away from the at least one peak portion.

28. A web tension indicator comprising:
a cylindrical housing defining at least one channel therein,
a barrel longitudinally received within the cylindrical housing, the barrel having an outer surface defining a tension indicating surface along a portion thereof, the barrel and cylindrical housing each configured to receive a web transversely therethrough,
a spring engaging the housing and the barrel to resist rotation of the barrel within the housing, wherein the barrel is responsive to a force applied by the web, resulting from tension applied to the web, to overcome tension in the spring and rotate the barrel relative to the housing so that the tension indicating surface of the barrel is visible through the at least one channel.

29. The web tension indicator of claim 28 wherein the spring is normally biased to position the tension indicating surface of the barrel away from the at least one channel so that the tension indicating surface of the barrel is not visible through the at least one channel.

30. The web tension indicator of claim 29 wherein an outer surface of the barrel other than that defining the tension indicating surface is visible through the at least one channel when the spring is normally biased.
